(19) United States
(12) Patent Application Publication
(10) Pub. No.: US 2020/0086853 A1
(43) Pub. Date: Mar. 19, 2020

(54) METHOD AND APPARATUS FOR VEHICULAR POSITION BASED PARKING ASSISTANCE ENHANCEMENTS

(71) Applicant: QUALCOMM Incorporated, San Diego, CA (US)

(72) Inventors: Akash KUMAR, Hyderabad (IN); Ankita, Hyderabad (IN); Amit JAIN, San Diego, CA (US)

(21) Appl. No.: 16/135,654

(22) Filed: Sep. 19, 2018

(51) Int. Cl. B60W 30/06; G05D 1/00; G06Q 30/02; H04W 4/44; H04W 4/46

(52) U.S. Cl. CPC B60W 30/06; G05D 1/0088; G05D 2201/0213; H04W 4/44; H04W 4/46; G06Q 30/0207

(57) ABSTRACT

An incoming autonomous or semi-autonomous vehicle may initiate/receive parking assist by providing a credit offer to parked vehicles to autonomously move or relocate so that the incoming vehicle has space to park. The incoming vehicle may send a park assist request to a parking control server or parked vehicles, including a credit offer to provide an incentive to parked vehicles to move. In response, a parking location for the incoming vehicle along with target vehicles near the parking location that may be moved may be provided to the incoming vehicle. The target vehicles may accept or reject a request to move, along with the credit offer, e.g., in a park assist negotiation with the incoming vehicle or the parking control server. Upon acceptance of the credit offer, one or more target vehicles may move or relocate to provide room for the incoming vehicle to park.

### BACKGROUND

Background Field

The subject matter disclosed herein relates to wireless communications systems, and more particularly to methods and apparatuses for wirelessly assisting in parking of vehicles.

### RELEVANT BACKGROUND

With an ever increasing number of vehicles, optimizing parking space is a major challenge across the globe. Manually parking vehicles is dependent on the skill and driving capability of the driver/user. One way to increase the amount of available parking for vehicles is to decrease the size of parking spaces, which will further stress the skills of the driver when manually parking. Fully autonomous and advanced driver-assistance system (ADAS) based semi-autonomous vehicles, however, are becoming more prevalent and will continue to do so in the future. The presence of autonomous and semi-autonomous vehicles may be exploited to assist in the parking (entry or exit) of the incoming and the outgoing vehicles.

Autonomous and semi-autonomous vehicles may use sensors and computer vision methods to dynamically sense and determine if a certain parking space can accommodate the vehicle and, if so, the vehicles may autonomously park in the parking space. With the use of autonomous and semi-autonomous vehicles, the skill and driving capability of a driver/user is no longer relevant to park a vehicle. Moreover, autonomous and semi-autonomous vehicles enable the size of individual parking spaces to be optimized to accommodate a greater number of vehicles within the same parking area.

Further improvements of the use of space in the parking area and the ability of autonomous or semi-autonomous vehicles to park, however, are possible and desirable.

### SUMMARY

An incoming autonomous or semi-autonomous vehicle may initiate/receive parking assist by providing a credit offer to parked vehicles to autonomously move or relocate so that the incoming vehicle has space to park. The incoming vehicle may send a park assist request to a parking control server or parked vehicles, including a credit offer to provide an incentive to parked vehicles to move. In response, a parking location for the incoming vehicle along with target vehicles near the parking location that may be moved may be provided to the incoming vehicle. The target vehicles may accept or reject a request to move, along with the credit offer, e.g., in a park assist negotiation with the incoming vehicle or the parking control server. Upon acceptance of the credit offer, one or more target vehicles may move or relocate to provide room for the incoming vehicle to park.

In one implementation, a method performed by a source vehicle for assisting in parking of the source vehicle includes sending a park assist request, wherein the park assist request comprises a credit offer to provide an incentive to a target vehicle that is autonomous to move to provide space for the source vehicle to park; receiving a park assist response directing the source vehicle to a parking space that is available after the target vehicle moves in response to the credit offer; and autonomously moving the source vehicle into the parking space after the target vehicle has moved.

In one implementation, a source vehicle capable of engaging in a parking assist session includes a wireless transceiver configured to wirelessly communicate with entities in a wireless network; sensors for receiving data used for parking assistance and autonomous and semi-autonomous driving and parking of the source vehicle; and at least one processor coupled to the wireless transceiver and the sensors and configured to: send a park assist request via the wireless transceiver, wherein the park assist request comprises a credit offer to provide an incentive to a target vehicle that is autonomous to move to provide space for the source vehicle to park; receive a park assist response via the wireless transceiver directing the source vehicle to a parking space that is available after the target vehicle moves in response to the credit offer; and autonomously move the source vehicle, based at least in part on signals from the sensors, into the parking space after the target vehicle has moved.

In one implementation, a method performed by a parking control server for assisting a source vehicle to park includes receiving a park assist request from the source vehicle, wherein the park assist request comprises a credit offer to provide an incentive to one or more vehicles that is autonomous to move to provide space for the source vehicle to park; determining a target vehicle available to move to provide a parking space for the source vehicle to park based on the credit offer; and sending a park assist response to the source vehicle directing the source vehicle to the parking space that is available after the target vehicle moves in response to the credit offer.

In one implementation, a parking control server for assisting a source vehicle to park, includes an external interface configured to wirelessly communicate with entities in a wireless network; and at least one processor coupled to the external interface and configured to: receive, via the external interface, a park assist request from the source vehicle, wherein the park assist request comprises a credit offer to provide an incentive to one or more vehicles that are autonomous to move to provide space for the source vehicle to park; determine a target vehicle available to move to provide a parking space for the source vehicle to park based on the credit offer; and send, via the external interface, a park assist response to the source vehicle directing the source vehicle to the parking space that is available after the target vehicle moves in response to the credit offer.

### BRIEF DESCRIPTION OF THE DRAWING

Non-limiting and non-exhaustive aspects are described with reference to the following figures, wherein like reference numerals refer to like parts throughout the various figures unless otherwise specified.

FIG. 1 illustrates a wireless communication system that may provide parking assistance for an autonomous or semi-autonomous source vehicle.

FIGS. 2A and 2B illustrate top views of a source vehicle receiving parking assist to parallel park.

FIGS. 3A and 3B illustrate top views of a source vehicle receiving parking assist to park in a parking lot.

FIGS. 4A, 4B, and 4C illustrate examples of call flows for a park assist session with a credit offer.

FIG. 5 is a flow chart illustrating a parking assist process for an autonomous or semi-autonomous source vehicle that may be performed by the source vehicle, e.g., which may be incoming vehicle attempting to park.

FIG. 6 is a flow chart illustrating a parking assist process for an autonomous or semi-autonomous source vehicle that may be performed by a parking control server.

FIG. 7 is a diagram illustrating an example of a hardware implementation of a source vehicle capable of engaging in a parking assist session.

FIG. 8 is a diagram illustrating an example of a hardware implementation of a parking control server capable of engaging in a parking assist session.

### DETAILED DESCRIPTION

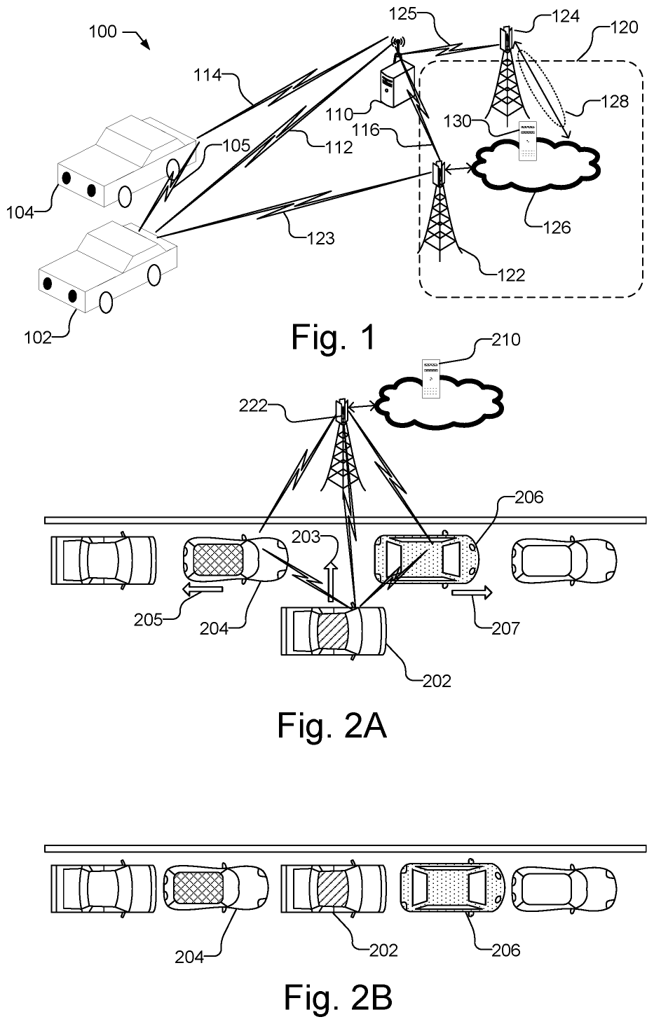

FIG. 1 illustrates a wireless communication system 100 that may provide parking assistance for an autonomous or semi-autonomous vehicle 102 (referred to herein as a source vehicle 102). The wireless communication system 100 may use, e.g., Vehicle-to-Everything (V2X) communication standard, in which information is passed between a vehicle and other entities within the wireless communication network. The V2X services include, e.g., services for Vehicle-to-Vehicle (V2V), Vehicle-to-Pedestrian (V2P), Vehicle-to-Infrastructure (V2I), and Vehicle-to-Network (V2N). The V2X standard aims to develop autonomous or semi-autonomous driving systems, such as ADAS, which helps drivers with critical decisions, such as lane changes, speed changes, overtaking speeds, and may be used to assist in parking as discussed herein. Low latency communications are used in V2X and, are therefore suitable for precise positioning. For example, current positioning techniques, such as time of arrival (TOA), time difference of arrival (TDOA) or observed time difference of arrival (OTDOA), or any other cellular positioning technique, may be enhanced using assistance from V2X. Thus, the use of V2X communication standard may be used to achieve and provide a high degree of safety for pedestrians, moving vehicles, etc.

In general, there are two modes of operation for V2X services, as defined in Third Generation Partnership Project (3GPP) TS 23.285. One mode of operation uses direct wireless communications between V2X entities when the V2X entities are within range of each other. The other mode of operation uses network based wireless communication between entities. The two modes of operation may be combined or other modes of operation may be used if desired.

As illustrated in FIG. 1, the wireless communication system 100 may operate using direct or indirect wireless communications between the source vehicle 102 and other entities, such as a parking control server 110 and vehicle 104. For example, the wireless communication may be over, e.g., Proximity-based Services (ProSe) Direction Communication (PC5) reference point as defined in 3GPP TS 23.303, and may use wireless communications under IEEE 1609, Wireless Access in Vehicular Environments (WAVE), Intelligent Transport Systems (ITS), and IEEE 802.11p, on the ITS band of 5.9 GHz, or other wireless connections directly between entities. Thus, as illustrated, the source vehicle 102 may directly communicate with various other entities within the wireless network, including the parking control server 110 in a Vehicle-to-Infrastructure (V2I) communication link 112 or another vehicle 104 in a Vehicle-to-Vehicle (V2V) communication link 105, and the other vehicle 104 may communicate with, e.g., the parking control server 110 in a V2I communication link 114. The parking control server 110, for example, may be a stationary infrastructure entity supporting V2X applications that can exchange messages with other entities supporting V2X applications. During direct communications with one or more entities in the V2X wireless communication system 100, each entity provides V2X information, such as an identifier for the V2X entity, as well as other information in messages such as Common Awareness Messages (CAM) and Decentralized Notification Messages (DENM) or Basic Safety Message (BSM), which may be used for, e.g., Advanced Driver Assistance System (ADAS) or safety use cases, e.g., for parking assistance.

Additionally, as illustrated in FIG. 1, the wireless communication system 100 may operate using indirect wireless communications, e.g., using a network based wireless communication between entities, such as Wireless Wide Area Networks (WWAN). For example, entities may communicate via the Long Term Evolution (LTE) network, where the radio interface between the user equipment (UE) and the eNodeB is referred to as LTE-Uu, or other appropriate wireless networks, such as “3G,” “4G,” or “5G” networks. As illustrated, the source vehicle 102 may wirelessly communicate with various other V2X entities, such as the parking control server 110 through a network infrastructure 120, which for the sake of example, may be a 5G network. The source vehicle 102, for example, may wirelessly communicate with a base station 122, referred to as a gNB in the network infrastructure 120, via a Uu interface 123. In some implementations, the base station 122 may directly communicate with the parking control server 110 via communication link 116. The base station 122 may also communicate with other base stations (e.g., gNBs) 124 through the IP layer 126 and network 128, such as an Evolved Multimedia Broadcast Multicast Services (eMBMS)/Single Cell Point To Multipoint (SC-PTM) network. A V2X application server (or another parking control server) 130 may be part of or connected to the IP layer 126 and may receive and route information between the V2X entities as well as receive other external inputs. The base station 124 may wirelessly communicate with the other V2X entities, such as the parking control server 110 via Uu interface 125 or other vehicle 104 via a Uu interface (not shown).

The V2X communications based on direct wireless communications between the V2X entities, such as that illustrated in FIG. 1, do not require any network infrastructure for the V2X entities to communicate and enable low latency communications, which is advantageous for precise positioning. Accordingly, such direct wireless V2X communications may be used to enhance the performance of current positioning techniques, such as TOA, TDOA or OTDOA.

The parking control server 110 (and/or 130) may be used to provide parking assistance to autonomous vehicles, such as source vehicle 102. In addition to simply determining an unoccupied parking slot based on the dimensions of the source vehicle 102, the parking control server 110 may be used to incentivize other autonomous or semi-autonomous vehicles to move in order to provide space to accommodate the incoming source vehicle 102. For example, there may be insufficient space for the source vehicle 102 to park, but other vehicles may be incentivized to move slightly within their own parking spaces to produce enough space to accommodate the source vehicle 102. In other cases, vehicles may be incentivized to autonomously move from its present parking space to a different parking space in order to provide the source vehicle 102 with a desired parking space, e.g., which may be near an electric charging station, near an exit, etc.

Without incentivizing other vehicles to move for the source vehicle 102, there may be no reason that a parked vehicle would or should move for another vehicle. For example, in order for a parked vehicle to move for another incoming vehicle, the parked vehicle must use fuel or electric power. Moreover, if the parked vehicle is moved from its current parking space, the owner/user may be required to search for the missing vehicle which may be in a more inconvenient location for the own/user.

Incentives that may be provided to a parked vehicle to move so that a source vehicle 102 may include, e.g., credit, money, or another type of incentive. For example, the credit may be a parking credit associated with the parking location, e.g., so that the cost of parking for the parked vehicle may be reduced to provide an incentive. Conversely, the source vehicle may provide the credit, and thus, the cost of parking may be increased source vehicle. The credit (or other payment) may be facilitated by the parking control server 110, which may be associated with a specific parking location, e.g., parking lot, or may be associated with multiple parking locations. Additionally, the incentives provided may vary based on the amount of movement of the parked vehicle that is required. For example, a smaller incentive may be required for a parked vehicle to move only a few feet to provide the necessary space for the source vehicle, while a greater incentive may be required for the parked vehicle to move from a first parking location to a second parking location, which may be less desirable, so that the source vehicle can park in the first parking location.

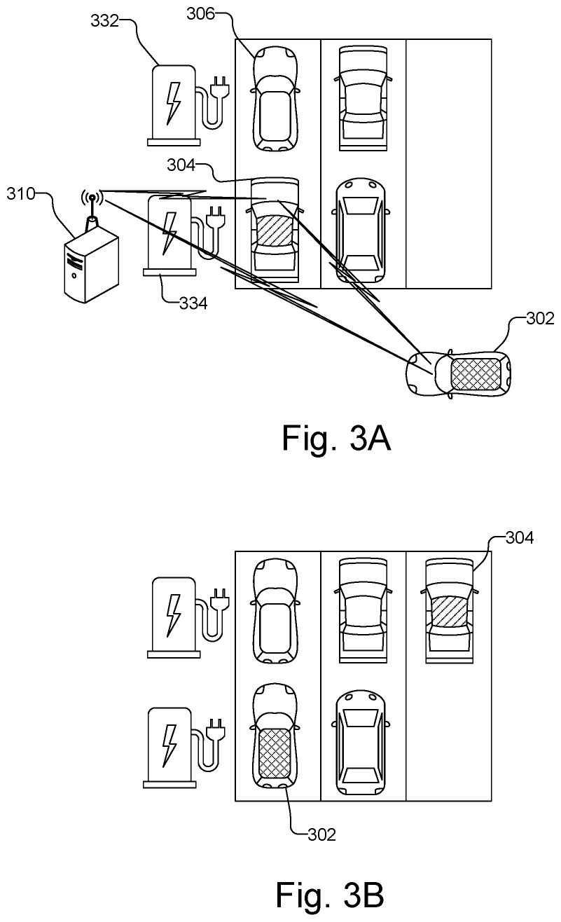

FIGS. 2A and 2B illustrate top views of a source vehicle receiving parking assist to parallel park. As illustrated, the source vehicle 202 may wirelessly communicate with a parking control server 210, e.g., through a base station 222. The source vehicle 202 may send a park assist request to the parking control server 210 with a credit offer for a parked vehicle that is available to move to provide space for the source vehicle 202. In another implementation, the source vehicle 202 may send the park assist request directly to one or more target vehicles 204, and 206, e.g., using a V2V communication link, thereby avoiding the need for the parking control server 210. The park assist request may include additional parameter, such as the vehicle identifier, size, type, priority level, a vehicle time to exit or park time, etc. The source vehicle 202, for example, may send the park assist request when the source vehicle 202 enters the parking structure is near an area where parking is desirable. The sending of the park assist request, for example, may be triggered by the user or when the autonomous or semi-autonomous source vehicle 202 enters a parking mode. The parking mode, for example, may be a mode entered into by the autonomous or semi-autonomous vehicle by user/drive instructions or at the completion of a planned trip, or other factor, and in which the autonomous or semi-autonomous vehicle searches for and executes a parking operation.

The parking control server 210 (or one or more of target vehicles 204, 206) may direct to the source vehicle 202 to a location where parking is available. For example, as shown in FIG. 2A, the source vehicle 202 has been directed to a location where parking is available between the target vehicles 204 and 206. The parking control server 210, for example, stores data related to the space around each vehicle, e.g., distance in front and behind, that the parking control server 210 assists in parking, along with other parameters, such as the priority of a vehicle, time to exit or remaining parking time, the battery or fuel level of a vehicle, whether a vehicle may be autonomously moved to provide space for incoming vehicles, and pre-set threshold for credits that would be required for the vehicle to move. Whether a parked vehicle may be autonomously moved, and by how much, and the incentives required for moving may be user/owner defined parameters. Further, some vehicles, such as emergency or service vehicles, may have higher priority than other vehicles, which may impact whether these vehicles may be moved to provide space for an incoming vehicle.

In some implementations, the parking control server 210 may consider additional factors when determining a parking location for the source vehicle. For example, the parking control server 210 may attempt to sparsely distribute autonomous vehicles, so that manual vehicles may be parked between autonomous vehicles, e.g., so that the autonomous vehicles may move to create more space for a manual driver. Another consideration may be the time to exit. The parking control server 210, for example, may distribute vehicles so that vehicles having different exit times are parked together, i.e., the parking control server 210 avoids parking vehicles with the same exit times near each other to avoid congestion. The time to exit may be included, e.g., by the user, in the park assist request or may be prompted by the parking control server 210 during entry or updated by the user later during or after parking. The parking control server 210 may further communicate with a user to suggest delaying exiting, e.g., if nearby vehicles have the same or similar intended exit time. The time to exit may be used as a factor when deciding which parked vehicles to move or relocate to create space for the source vehicle.

The parking control server 210 may determine whether a space is available for the source vehicle 202 and if not, whether any parked vehicles may be moved to provide space for the source vehicle 202. The parking control server 210, for example, may locate a space for source vehicle 202 based available space around the parked vehicles as well as the credit offer provided by the source vehicle 202, e.g., whether there are any parked vehicles that are available to be autonomously moved and the offered credit is above the pre-set threshold for the parked vehicles. Other considerations may include, e.g., the battery or fuel of parked vehicles, priority or type of source vehicle 202 and the parked vehicles.

After the parking control server 210 determines an available parking space for the source vehicle 202, e.g., after one or more parked vehicles move in response to the credit offer, the parking control server 210 may send a park assist response to the source vehicle 202. In V2V implementations, one or more of the target vehicles 204 and 206 may send the park assist response to the source vehicle 202. The park assist response may, e.g., direct the source vehicle 202 to the parking space. As illustrated by arrow 203, the source vehicle 202 is directed to park between target vehicles 204 and 206. As illustrated, by arrows 205 and 207, however, both target vehicles 204 and 206 are required to move in order for the source vehicle 202 to have adequate space to park. As illustrated in FIG. 2A, the parking control server 210 may communicate with the target vehicles 204 and 206 via base station 222. Additionally, or alternatively, the source vehicle 202 may communicate directly with the target vehicles 204 and 206. The parking control server 210 or the source vehicle 202, for example, may communicate with the target vehicles 204 and 206 with a park assist negotiation request. The park assist negotiation request, for example, may include the offered credit as well as other factors, such as the priority of the source vehicle 202, with a request that the target vehicles 204 and 206 use their sensors to detect the space around them and move themselves as much as they can, as illustrated by arrows 205 and 207.

The target vehicles 204 and 206 may communicate with the parking control server 210 or the source vehicle 202 to provide a park assist negotiation response that accepts or rejects the movement request from the source vehicle 202. If the target vehicles 204 and 206 accept the movement request, the target vehicles 204 and 206 may also communicate the distance that they can move and the space that they can create for the source vehicle 202, which may be useful, e.g., if this data is not otherwise stored in the parking control server 210. This information may be used to determine if the source vehicle 202 is able to park at that location, and if so, the target vehicles 204 and 206 are instructed to autonomously move and the credits are transferred. The source vehicle 202 may then, e.g., autonomously or semi-autonomously park, park in the space provided, as illustrated in FIG. 2B.

In one implementation, the source vehicle 202 may send a “Request to park” beacon including a credit offer to the multiple parked vehicles, e.g., target vehicles 204 and 206. The target vehicles may accept or rejection the request in a response based on the credit offer, as well factors, such as the time to exit criteria.

When source vehicle 202 is being parked, nearby target vehicles, e.g., target vehicles 204 and 206 turn ON their sensors and V2X system and may move or relocate based on the space available, e.g., in response to accepting the credit offer in the request to move or in response to detecting the source vehicle 202 is about to hit a target vehicle. Additionally, the vehicles 202, 204, and 206 may turn on cameras, such as a dash camera to record the parking of the source vehicle 202 and movement/relocation of the target vehicles 204 and 206, e.g., for insurance purposes in case of contact between vehicles. In some implementations, the video may be auto-updated to the servers of the insurance company associated with the vehicle or saved for future use.

If desired, once parking is completed, a park assist confirmation may be sent by the source vehicle 202 to the parking control server 210, if used. The park assist confirmation may indicate that parking is completed and may include information, such as the space/distance around the source vehicle 202, e.g., to the front and rear of the vehicle, as well as other information, such as the priority of the source vehicle 202, time to exit or remaining parking time, the battery or fuel level, whether the source vehicle 202 may be autonomously moved to provide space for incoming vehicles, and pre-set threshold for credits that would be required for the vehicle to move.

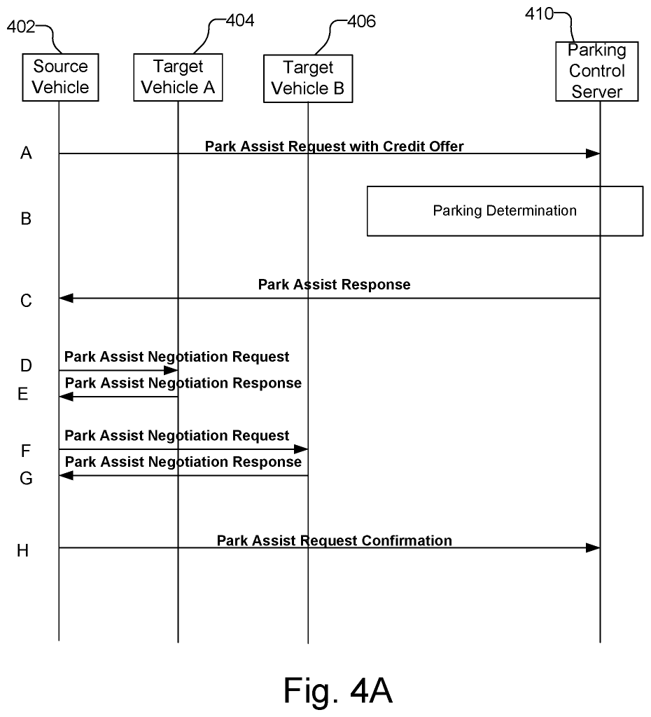

FIGS. 3A and 3B illustrate top views of a source vehicle receiving parking assist to park in a parking lot. As illustrated, two of the six parking spaces are near an electric charging station, as indicated by charge stations 332 and 334. In some implementations, the electric charging stations may be wireless charging stations, such as the Qualcomm Halo™ Wireless Electric Vehicle Charging or other similar wireless charging technology. While two parking spaces are available, source vehicle 302 requires charging. Accordingly, the source vehicle 302 may wirelessly send a park assist request to the parking control server 310 or directly to target vehicles, such as target vehicles 304 and 306. Source vehicle 302, for example, may request a parking space at a charging station, and may provide a credit offer with the park assist request to provide an incentive for a vehicle parked at a charging station to relocate so that source vehicle 202 may use the charging station. The park assist request may include additional parameters, such as the vehicle identifier, size, type, priority level, a vehicle time to exit or park time, etc.

As illustrated, the parking control server 310 and/or the source vehicle 302 may wirelessly communicate with the target vehicle 304. The parking control server 310 (or source vehicle 302) may negotiate with the target vehicle 304 to determine if the target vehicle will accept the credit offer to relocate from the charging station. By way of example, the target vehicle 304 may be willing to relocate for the credit offer if the target vehicle 304 is fully charged or adequately charged. If the target vehicle 304 does not accept the credit offer, the parking control server 310 may wireless connect to a different target vehicle, e.g., vehicle 306, to negotiate the credit offer and relocation. If the target vehicle 304 accepts the credit offer, the parking control server 310 may direct the target vehicle to a new parking location, and may direct source vehicle to the parking location with the charging station, as illustrated in FIG. 3B. In one implementation, e.g., where the vehicle is semi-autonomous and the user/driver is present, the user/driver may unplug the target vehicle 304 and plug in the source vehicle 302 to the charging station, or a parking lot attendant may do so. In another example, the charging station may be a wireless charging station, such as the Qualcomm Halo™ Wireless Electric Vehicle Charging or other similar wireless charging technology, and thus the target vehicle 304 and source vehicle 302 do not need to be unplugged or plugged in. Once parked, the source vehicle 302 may provide a park assist confirmation indicating that the park assist is complete and the source vehicle 302 is parked. The transfer of the credits from the credit offer may occur with the park assist confirmation or in a previous message, e.g., during negotiations with the target vehicle 304. The park assist confirmation may further include information, such as the space/distance around the source vehicle 302, the priority of the source vehicle 202, time to exit or remaining parking time, the battery or fuel level, whether the source vehicle 202 may be autonomously moved to provide space for incoming vehicles, and one or more pre-set threshold for credits that would be required for the vehicle to move, e.g., different credit thresholds may be used when the source vehicle 302 is at different charging levels.

The park assist with credit offer may be implemented, e.g., using the V2X Specification. For example, the message payloads in the V2X specification may be defined. Using these V2X messages with defined payloads, interaction between the source vehicle, the parking control server, and the target vehicles may occur. Alternatively, a standalone application may be used, in which all users, e.g., source vehicle, target vehicle and parking control server install a dedicated application that performs the parking control behavior and obtains the request from the clients, e.g., vehicles, as described herein. On the vehicles, the application would access the sensors data and communicate with the vehicles to implement the parking assist.

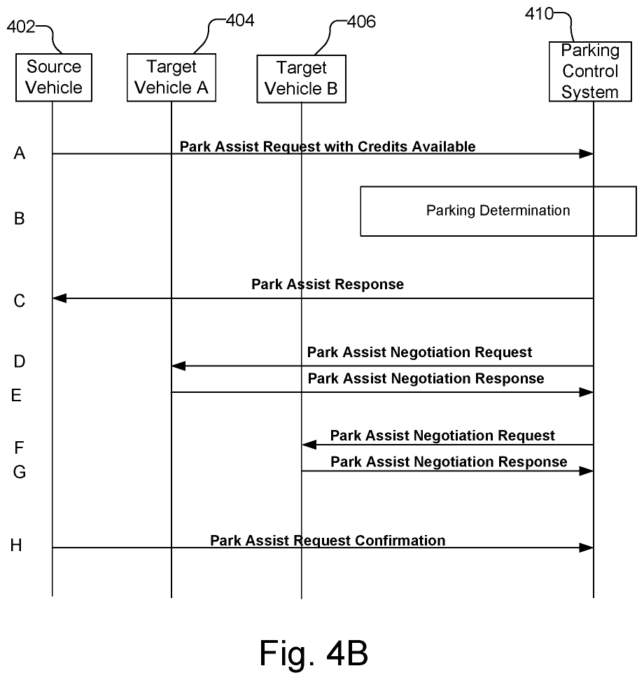

FIGS. 4A, 4B, and 4C, by way of example, illustrate examples of call flows for a park assist session with a credit offer, e.g., using PC5 based negotiation, with negotiation with target vehicles performed by the source vehicle and parking control server. As illustrated at stage A, a source vehicle 402 may send a park assist request message to a parking control server 410. The park assist request message includes a credit offer. The park assist request message may include additional information. For example, the payload of the message may contain the vehicle ID, size, type, priority, credit offer, vehicle time to exit, vehicle park time etc. By way of example, Table 1 illustrates possible park assist Request and Response message header for a V2X message.

TABLE 1

| Field | Value |
|---|---|
| Vehicle ID (M) | 12 Bytes |
| Vehicle Size (M) | Enum {E0, E1, En}, L × B × H - 20 bytes |
| Vehicle Type (M) | Enum {Personal, Commercial, Emergency, . . . } |
| | Enum {Electric, Non-Electric} - fuel indicator |
| Vehicle Priority (M) | Assigned by PCS enum {0, 1 . . . 512} - 2 bytes |
| Vehicle Credit offer | Enum {0 . . . 63} |
| (O) | |
| Vehicle Park Time | Enum {0..63} or Discrete time in hrs |
| Vehicle Time to Exit | HH:MM |
| Impacted Vehicle List | List {0, |
| (O) | 1, . . . |
| | 63} - Ordered list contains the vehicle ID with |
| | whom the current vehicle communicates and |
| | negotiates |

At stage B, the parking control server 410 determines one or more parking locations for the source vehicle, including a list of target vehicles that are available to be moved to provide a parking space for the source vehicle based on the credit offer. Factors used to determine parking locations for the source vehicle may include information about the source vehicle, e.g., the size, type, priority, need for electric charge, etc., and information about available parking space, e.g., size of any available space, list of parked vehicles that are available to be moved in response to the offered credit, including locations, space around the parked vehicles, and pre-set credit thresholds. The list of the target vehicles may be determined by the parking control server 410 based on factors such as the battery/fuel used by the target vehicles in providing the parking assistance (e.g., if the target vehicles have been previously moved), if the offered credit is above pre-set thresholds for the target vehicles, the priority/type of the target vehicle, etc.

At stage C, the parking control server 410 provides a park assist response message to the source vehicle 402. The park assist response message, for example, may be generated by appending the payload to the park assist request message from stage A. The park assist response message may provide, e.g., the location of an available parking location and the list of target vehicles 404 and 406 available to be moved to provide space for the source vehicle 402. The park assist response message may further assign the priority to the source vehicle 402.

A park assist negotiation is then initiated with target vehicles from the list of target vehicles generated by the parking control server 410. The park assist negotiation may occur between the source vehicle 402 and the target vehicles or between the parking control server 410 and the target vehicles. Thus, as illustrated in FIG. 4A, at stage D the source vehicle 402 sends a park assist negotiation request message to target vehicle A 404 and at stage E receives a park assist negotiation response message from the target vehicle A 404. Similarly, at stage F the source vehicle 402 sends a park assist negotiation request message to target vehicle B 406 and at stage G receives a park assist negotiation response message from the target vehicle B 406. Similarly as illustrated in FIG. 4B, at stage D the parking control server 410 sends a park assist negotiation request message to target vehicle A 404 and at stage E receives a park assist negotiation response message from the target vehicle A 404. Similarly, at stage F the parking control server 410 sends a park assist negotiation request message to target vehicle B 406 and at stage G receives a park assist negotiation response message from the target vehicle B 406.

The park assist negotiation request messages at stages D and F may be initiated based on the identity of the target vehicles determined by the parking control server 410 (and provided to source vehicle 402 at stage C in FIG. 4A) and may include, along with the movement request, the credit offer from the source vehicle 402, and other information, such as sharing the priority of the vehicle and other factors. The park assist negotiation response messages at stages E and G may include an acceptance or rejection of the movement request from the source vehicle. A park assist negotiation response message may further include the distances that a target vehicle may move and the space that may be created. The park assist negotiation request messages may be transmitted sequentially, e.g., the park assist negotiation request message to target vehicle B 406 is sent if target vehicle A 404 rejects the movement request or if the space created by the movement of target vehicle A 404 is insufficient for source vehicle 402. In some implementations, multiple park assist negotiation request messages and park assist negotiation response messages may be transmitted between source vehicle 402 and a target vehicle. For example, if the space created by the movement of target vehicle A 404 is insufficient for source vehicle 402, the park assist negotiation may be engaged with target vehicle B 406. Upon acceptance of the request for movement by target vehicle B 406, and if the combined movement of target vehicle A 404 and target vehicle B 406 is required to provide space for source vehicle 402, the park assist negotiation with target vehicle A 404 may be re-engaged so that both target vehicle A 404 and target vehicle B 406 will move.

The target vehicles that accept the request for movement based on the credit offer may use their sensors to detect the space around them and autonomously move as much as they can to provide room for the source vehicle 402. Optionally, the target vehicles may move again to adjust distance between vehicles after the source vehicle is parked (the source vehicle may send messages to the target vehicles informing them that parking is completed. If a target vehicle is required to relocate to another parking location, e.g., as illustrated in FIGS. 3A and 3B, the target vehicle may wirelessly engage in a park assist session with a credit offer with the parking control server 410 in discussed above.

At stage H, the source vehicle 402 may optionally send a park assist request confirmation message to the parking control server 410 after the park assist is complete and source vehicle 402 is parked. In the park assist request confirmation message, the source vehicle may include a payload containing the space/distance at the front and rear of the source vehicle 402, as well as the preset credit threshold for the source vehicle 402. The parking control server 410 may use this information from the source vehicle 402, as well as all other vehicles that used park assist, to map the distance between multiple vehicles and hence can be used to determine the best parking space for any incoming vehicle, the list of impacted vehicles based on whether they will accept a credit offer, etc.

The credit exchange between the source vehicle and any target vehicle that has moved may occur, e.g., after acceptance of the credit offer during the park assist negotiation or after the park assist request confirmation. The credit exchange, for example, may performed within the parking control server 410 in which credits may be increased for target vehicles that moved and decreased for the source vehicle 402. The parking control server 410, for example, may have the identification of the source vehicle 402 and any target vehicle that moved, and may record information the credit transfer using the identification. For example, upon exiting of the vehicles, the parking fees for the source vehicle 402 and any target vehicles may be appropriately adjusted by the parking control server 410. In another implementation, e.g., where the offered incentive is money, the credit exchange may be a transfer of money directly between the vehicles.

Similarly, as illustrated in FIG. 4B, at stage D the parking control server 410 sends a park assist negotiation request message to target vehicle A 404 and at stage E receives a park assist negotiation response message from the target vehicle A 404. Similarly, at stage F the parking control server 410 sends a park assist negotiation request message to target vehicle B 406 and at stage G receives a park assist negotiation response message from the target vehicle B 406.

FIG. 4C is similar to FIG. 4A but does not use a parking control server. As illustrated by stage A, the source vehicle 402 may send a park assist request message to target vehicle A 404 and target vehicle B 406. The park assist request message, for example, may be broadcast by source vehicle 402 or may be sent directly between the source vehicle 402 and each target vehicle. The park assist request message may be similar to the park assist request message sent to the parking control server 410 in FIGS. 4A and 4B. For example, the park assist request message may include a credit offer as well as additional information that may be used by the target vehicles 404 and 406 to make a parking determination in stage B. Unlike parking control server 410, each target vehicle may determine how much space is available near the target vehicle, as opposed to the entire parking lot, and whether there is space to accommodate source vehicle 402, e.g., if the target vehicle moves.

The source vehicle 402 may receive park assist responses from one or more target vehicles 404 and 406 at stage C. The park assist response message, for example, may be generated by appending the payload to the park assist request message from stage A. The park assist response message may provide, e.g., the location of an available parking location, e.g., near the sending target vehicles 404 and 406. Similar to the discussion in FIG. 4A, the source vehicle 402 may initiate park assist negotiations, shown in stages D, E, F, and G, with the target vehicles that sent the park assist response in stage C.

The target vehicles that accept the request for movement based on the credit offer may use their sensors to detect the space around them and autonomously move as much as they can to provide room for the source vehicle 402. Optionally, the target vehicles may move again to adjust distance between vehicles after the source vehicle is parked (the source vehicle may send messages to the target vehicles informing them that parking is completed. If a target vehicle is required to relocate to another parking location, e.g., as illustrated in FIGS. 3A and 3B, the target vehicle may wirelessly engage in a park assist session with a credit offer with the parking control server 410 in discussed above.

At stage H, the source vehicle 402 may optionally send a park assist request confirmation message to one or both of the target vehicles 404 and 406 after the park assist is complete and source vehicle 402 is parked. The credit exchange between the source vehicle and any target vehicle that has moved may occur, e.g., after acceptance of the credit offer during the park assist negotiation or after the park assist request confirmation. As no parking control server 410 is used, the credit exchange may be between the source vehicle 402 and the target vehicle that moved and may be, e.g., a transfer of money directly between the vehicles.

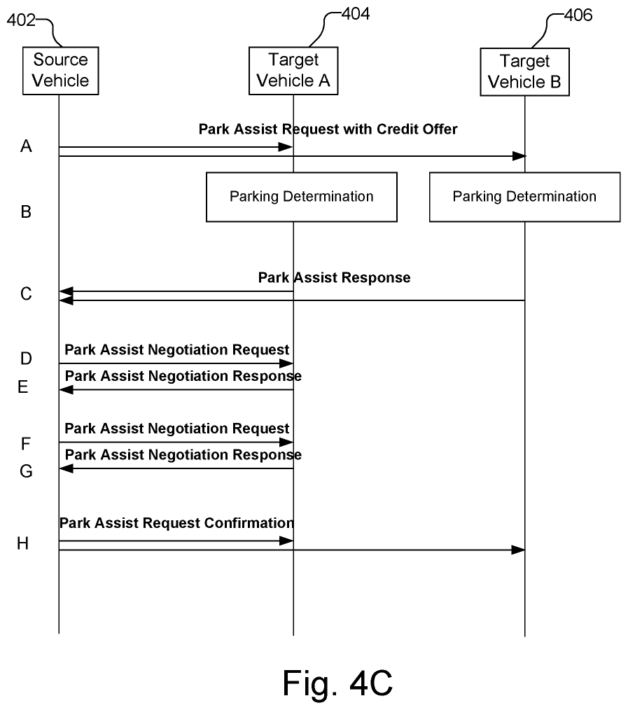

FIG. 5 is a flow chart illustrating a parking assist process 500 performed by a source vehicle for assisting in parking of the source vehicle, e.g., which may be incoming vehicle attempting to park. As illustrated, at block 502, the source vehicle sends a park assist request to a parking control system, wherein the park assist request comprises a credit offer to provide an incentive to a target vehicle that is autonomous to move to provide space for the source vehicle to park. In addition to the credit offer, the park assist request may include at least one of a vehicle identification, size, type, priority, vehicle time to exit, vehicle park time, or a combination thereof. By way of example, block 502 may be consistent with stage A in FIGS. 4A and 4B.

At block 504, the source vehicle receives a park assist response from the parking control server directing the source vehicle to a parking space that is available after the target vehicle moves in response to the credit offer. By way of example, block 504 may be consistent with stage C in FIGS. 4A and 4B. The parking assist may include an identifier for the target vehicle and the process may further include the source vehicle sending a negotiation request to the target vehicle with the credit offer for the target vehicle and receiving a negotiation response from the target vehicle with an acceptance of the credit offer, wherein the target vehicle autonomously moves after accepting the credit offer, as illustrated at stages D and E in FIG. 4A. The park assist response may include an identifier for multiple target vehicles, and the process may further include the source vehicle sending negotiation requests to each of the multiple target vehicles with the credit offer for the target vehicle and receiving a negotiation response from the multiple target vehicles in which at least one target vehicle in the multiple target vehicles accepts the credit offer, wherein the at least one target vehicle in the multiple target vehicles autonomously moves after accepting the credit offer, as illustrated at stages D, E, F, and G in FIG. 4A. For example, a plurality of target vehicles in the multiple target vehicles accept the credit offer, and the plurality of target vehicles may autonomously move after accepting the credit offer to provide space for the source vehicle to park. In one implementation, sending negotiation requests to each of the multiple target vehicles may include the source vehicle sending a first negotiation request to a first target vehicle and receiving a first negotiation response from the first target vehicle with a rejection of the credit offer; and the source vehicle sending a second negotiation request to a second target vehicle after receiving the first negotiation response; and receiving a second negotiation response from the second target vehicle with the acceptance of the credit offer. In another implementation, sending negotiation requests to each of the multiple target vehicles may comprise sending the negotiation requests to each target vehicle in the multiple target vehicles before receiving a negotiation response from any of the target vehicles.

In another implementation, the parking control server negotiates with the target vehicle and receives an acceptance of the credit offer from the target vehicle, as illustrated at stages D, E, F, and G in FIG. 4B. For example, the parking control server may receive the acceptance of the credit offer from the target vehicle before sending the park assist response to the source vehicle.

At block 506 the source vehicle autonomously moves into the parking space after the target vehicle has moved. In one implementation, the source vehicle may send a park assist confirmation to the parking control server, the park assist confirmation confirming that the source vehicle has parked at the parking space and comprising information related to space around the source vehicle, as illustrated at stage H in FIGS. 4A and 4B. The park assist confirmation may further include a desired credit to provide an incentive for the source vehicle to move to provide space for an incoming vehicle to park.

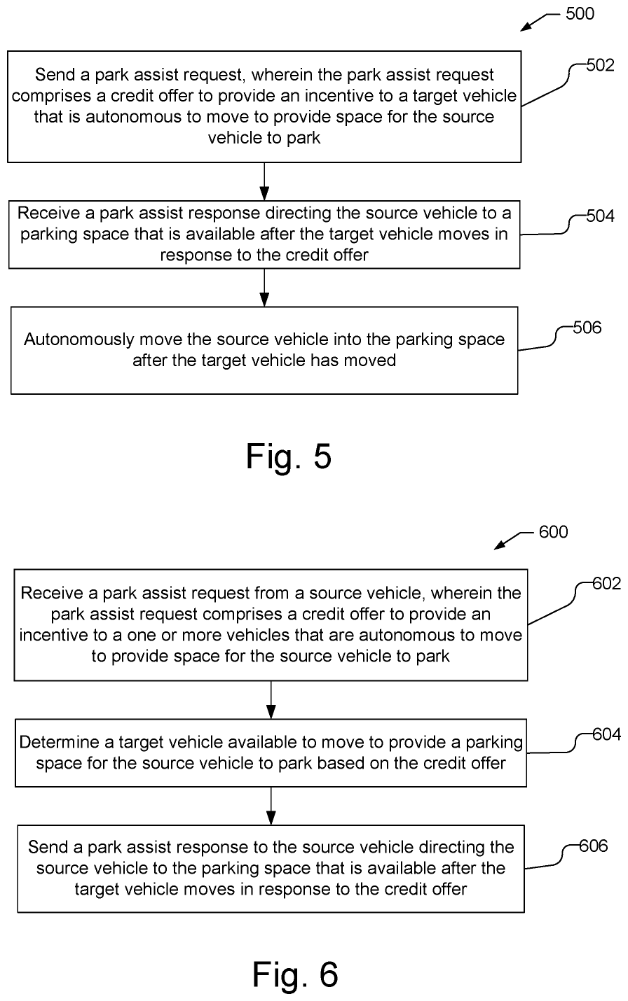

FIG. 6 is a flow chart illustrating a parking assist process 600 performed by a parking control server for assisting a source vehicle to park. As illustrated at block 602, the parking control server may receive a park assist request from the source vehicle, wherein the park assist request comprises a credit offer to provide an incentive to one or more vehicles that is autonomous to move to provide space for the source vehicle to park.

At block 604, the parking control server may determine a target vehicle available to move to provide a parking space for the source vehicle to park based on the credit offer, which may correspond to stage B in FIGS. 4A and 4B. The park assist request may include at least one of a vehicle identification, size, type, priority, vehicle time to exit, vehicle park time, or a combination thereof and the parking control server may determine the target vehicle available to move to provide the parking space for the source vehicle to park is further based on the at least one of a vehicle identification, size, type, priority, vehicle time to exit, vehicle park time, or a combination thereof.

At block 606, the parking control server may send a park assist response to the source vehicle directing the source vehicle to the parking space that is available after the target vehicle moves in response to the credit offer. By way of example, block 606 may be consistent with stage C in FIGS. 4A and 4B. The park assist response sent to the source vehicle may an identifier for the target vehicle and the source vehicle negotiates with the target vehicle and receives an acceptance of the credit offer from the target vehicle, as illustrated at stages D and E in FIG. 4A. The park assist response sent to the source vehicle includes identifiers for multiple target vehicles, and the source vehicle negotiates with the multiple target vehicles and receives an acceptance of the credit offer from at least one target vehicle in the multiple target vehicles, as illustrated at stages D, E, F, and G in FIG. 4A. For example, a plurality of target vehicles in the multiple target vehicles accept the credit offer, wherein the plurality of target vehicles autonomously move after accepting the credit offer to provide space for the source vehicle to park.

In another implementation, the parking control server may send a negotiation request from the parking control server to the target vehicle with the credit offer for the target vehicle and may receive a negotiation response from the target vehicle with an acceptance of the credit offer, wherein the target vehicle autonomously moves after accepting the credit offer, as illustrated at stages D and E in FIG. 4B. For example, the parking control server may receive the acceptance of the credit offer from the target vehicle before sending the park assist response to the source vehicle. In another implementation, the parking control server may send a negotiation request from the parking control server to multiple target vehicles with the credit offer for the multiple target vehicles to move to provide space for the source vehicle to park and may receive a negotiation response from the target vehicle with an acceptance of the credit offer from at least one target vehicle in the multiple target vehicles, as illustrated at stages D, E, F, and G in FIG. 4B.

In one implementation, the parking control server may receive a park assist confirmation from the source vehicle, the park assist confirmation confirming that the source vehicle has parked at the parking space and comprising information related to space around the source vehicle, e.g., as illustrated at stage H in FIGS. 4A and 4B. The park assist confirmation may further include a desired credit to provide an incentive for the source vehicle to move to provide space for an incoming vehicle to park.

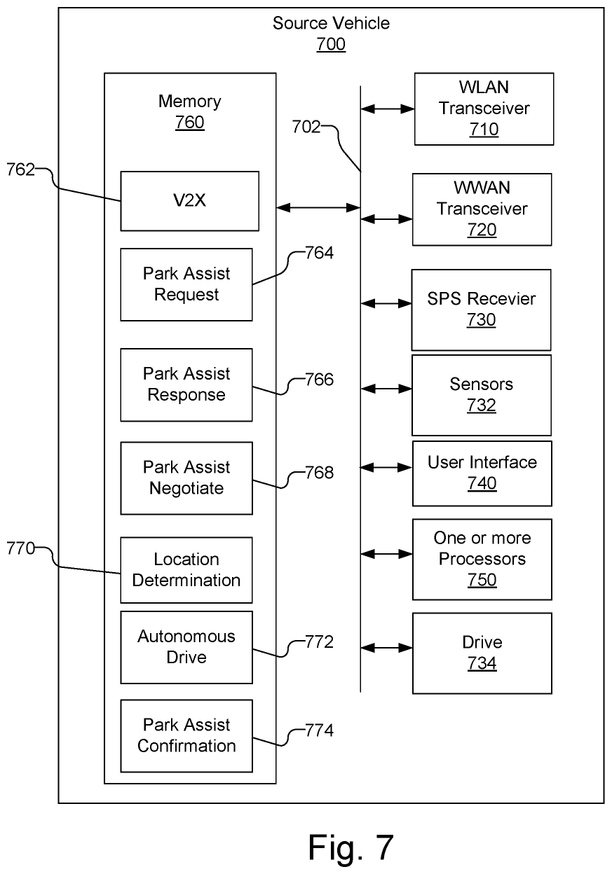

FIG. 7 is a diagram illustrating an example of a hardware implementation of a source vehicle 700 capable of V2X communications with V2X entities and engaging in a parking assist session as discussed herein. The source vehicle 700, for example, may include a Wireless Wide Area Network (WWAN) transceiver 720, including a transmitter and receiver, such as a cellular transceiver, configured to wirelessly communicate with a parking control server via base stations in the wireless network. The WWAN transceiver 720 may also be configured to wirelessly communicate directly with other V2X entities, such as target vehicles, e.g., using wireless communications under IEEE 802.11p on the ITS band of 5.9 GHz or other appropriate short range wireless communications. The source vehicle may further include a Wireless Local Area Network (WLAN) transceiver 710, including a transmitter and receiver, which may also be used to wirelessly communicate directly with other entities, and in some embodiments with V2X entities, such as a parking control server and/or target vehicles. The source vehicle 700 may further include an SPS receiver 730 with which SPS signals from SPS satellites may be received. The source vehicle 700 may further include sensors 732, such as ultrasonic sensors, cameras, computer vision, etc., that may be used for parking assistance and autonomous and semi-autonomous driving and parking. The source vehicle also includes a drive controller 734 that is used to control the source vehicle for autonomous and semi-autonomous driving and parking, e.g., based on the data from sensors 732. The source vehicle 700 may include additional features, such as user interface 740 that may include e.g., a display, a keypad or other input device, such as virtual keypad on the display, through which the user may interface with the source vehicle 700.

The source vehicle 700 further includes one or more processors 750 and memory 760, which may be coupled together with bus 702. The one or more processors 750 and other components of the source vehicle 700 may similarly be coupled together with bus 702, a separate bus, or may be directly connected together or coupled using a combination of the foregoing. The memory 760 may contain executable code or software instructions that when executed by the one or more processors 750 cause the one or more processors 750 to operate as a special purpose computer programmed to perform the techniques disclosed herein. As illustrated in FIG. 7, the memory 760 may include one or more components or modules that may be implemented by the one or more processors 750 to perform the methodologies described herein. While the components or modules are illustrated as software in memory 760 that is executable by the one or more processors 750, it should be understood that the components or modules may be dedicated hardware either in the one or more processors 750 or off the processors.

The memory 760 may include a V2X unit 762 that when implemented by the one or more processors 750 configures the one or more processors 750 cause the WWAN transceiver 720 or WLAN transceiver 710 to wirelessly communicate with Vehicle-to-Everything (V2X) entities, such as a parking control server or target vehicles. The V2X unit 762 enable the one or more processors 750 to transmit and receive V2X messages to and from a parking control server and target vehicles, e.g., with payloads that include information, e.g., as used by the park assist request unit 764, park assist response unit 766, park assist negotiate unit 768, and park assist confirmation unit 774.

The memory 760 may include a park assist request unit 764, that when implemented by the one or more processors 750 configures the one or more processors 750 to request parking assistance from a parking control server or one or more target vehicles via the WWAN transceiver 720 or WLAN transceiver 710. The park assist request unit 764 may cause the one or more processors 750 to include a credit offer in the park assist request to provide an incentive to a target vehicle that is autonomous to move to provide space for the source vehicle to park. In addition to the credit offer, the park assist request unit 764 may cause the one or more processors 750 to include at least one of a vehicle identification, size, type, priority, vehicle time to exit, vehicle park time, or a combination thereof.

The memory 760 may include a park assist response unit 766 that when implemented by the one or more processors 750 enables the one or more processors 750 to receive a park assist response message via the WWAN transceiver 720 or WLAN transceiver 710. The park assist response message for example may direct the source vehicle to an available parking space and may include a list of target vehicle that may move in response to the credit offer.

The memory 760 may include a park assist negotiate unit 768 that when implemented by the one or more processors 750 enables the one or more processors 750 to engage in a parking assist negotiation with one or more target vehicle via the WWAN transceiver 720 or WLAN transceiver 710, including sending and receiving negotiation messages. The park assist negotiate unit 768 when implemented by the one or more processors 750 may enable the one or more processors 750 to provide a credit offer to one or more target vehicles and enable the one or more processors 750 to receive a rejection or acceptance of the credit offer.

As illustrated, memory 760 may include additional executable code or software instructions necessary to enable autonomous and/or semiautonomous driving capabilities. For example, a location determination unit 770 that when implemented by the one or more processors 750 configures the one or more processors 750 to perform position determination using the received PRS signals, as well as sensors 732. An autonomous drive unit 772 when implemented by the one or more processors 750 configures the one or more processors 750 to control the source vehicle for autonomous or semi-autonomous driving and parking, e.g., using information obtained from the location determination unit 770 and the park assist response unit 766.

The memory 760 may include a park assist confirmation unit 774 that when implemented by the one or more processors 750 enables the one or more processors 750 to provide a parking assist confirmation message to the parking control server via the WWAN transceiver 720 or WLAN transceiver 710. The park assist confirmation message, for example, may confirm that the source vehicle has parked at the parking space and may include information related to space around the source vehicle (as determined by sensors 732 and location determination unit 770), and may further include a desired credit to provide an incentive for the source vehicle to move to provide space for an incoming vehicle to park.

The methodologies described herein may be implemented by various means depending upon the application. For example, these methodologies may be implemented in hardware, firmware, software, or any combination thereof. For a hardware implementation, the one or more processors 750 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of source vehicle 700 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a memory (e.g. memory 760) and executed by one or more processors 750, causing the one or more processors 750 to operate as a special purpose computer programmed to perform the techniques disclosed herein. Memory may be implemented within the one or processors 750 or external to the one or more processors 750. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by source vehicle 700 may be stored as one or more instructions or code on a non-transitory computer-readable storage medium such as memory 760. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for source vehicle 700 may be provided as signals on transmission media included in a communication apparatus. For example, a communication apparatus comprising part or all of source vehicle 700 may include a transceiver having signals indicative of instructions and data. The instructions and data are stored on non-transitory computer readable media, e.g., memory 760, and are configured to cause the one or more processors 750 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Thus, a source vehicle, such as source vehicle 700, may include a means for sending a park assist request to a parking control server, wherein the park assist request comprises a credit offer to provide an incentive to a target vehicle that is autonomous to move to provide space for the source vehicle to park, which may be, e.g., the WWAN transceiver 720 or WLAN transceiver 710 and one or more processors 750 with dedicated hardware or implementing executable code or software instructions in memory 760 such as the park assist request unit 764. A means for receiving a park assist response from the parking control server directing the source vehicle to a parking space that is available after the target vehicle moves in response to the credit offer may be, e.g., the WWAN transceiver 720 or WLAN transceiver 710 and one or more processors 750 with dedicated hardware or implementing executable code or software instructions in memory 760 such as the park assist response unit 766. A means for autonomously moving the source vehicle into the parking space after the target vehicle has moved may be, e.g., the WWAN transceiver 720 or WLAN transceiver 710, SPS receiver 730, sensors 732 and one or more processors 750 with dedicated hardware or implementing executable code or software instructions in memory 760 such as the location determination unit 770 and autonomous drive unit 772.

In one implementation, the source vehicle may include a means for sending a negotiation request to the target vehicle with the credit offer for the target vehicle, which may be, e.g., the WWAN transceiver 720 or WLAN transceiver 710 and one or more processors 750 with dedicated hardware or implementing executable code or software instructions in memory 760 such as the park assist negotiate unit 768, and a means for receiving a negotiation response from the target vehicle with an acceptance of the credit offer, wherein the target vehicle autonomously moves after accepting the credit offer, which may be the WWAN transceiver 720 or WLAN transceiver 710 and one or more processors 750 with dedicated hardware or implementing executable code or software instructions in memory 760 such as the park assist negotiate unit 768. In further example, the source vehicle may include a means for sending negotiation requests to each of the multiple target vehicles with the credit offer for the target vehicle, which may be the WWAN transceiver 720 or WLAN transceiver 710 and one or more processors 750 with dedicated hardware or implementing executable code or software instructions in memory 760 such as the park assist negotiate unit 768, and a means for receiving a negotiation response from the multiple target vehicles in which at least one target vehicle in the multiple target vehicles accepts the credit offer, wherein the at least one target vehicle in the multiple target vehicles autonomously moves after accepting the credit offer, which may be the WWAN transceiver 720 or WLAN transceiver 710 and one or more processors 750 with dedicated hardware or implementing executable code or software instructions in memory 760 such as the park assist negotiate unit 768. For example, the source vehicle may include a means for sending a first negotiation request to a first target vehicle, which may be the WWAN transceiver 720 or WLAN transceiver 710 and one or more processors 750 with dedicated hardware or implementing executable code or software instructions in memory 760 such as the park assist negotiate unit 768. A means for receiving a first negotiation response from the first target vehicle with a rejection of the credit offer may be, e.g., which may be the WWAN transceiver 720 or WLAN transceiver 710 and one or more processors 750 with dedicated hardware or implementing executable code or software instructions in memory 760 such as the park assist negotiate unit 768. A means for sending a second negotiation request to a second target vehicle after receiving the first negotiation response may be, e.g., the WWAN transceiver 720 or WLAN transceiver 710 and one or more processors 750 with dedicated hardware or implementing executable code or software instructions in memory 760 such as the park assist negotiate unit 768. A means for receiving a second negotiation response from the second target vehicle with the acceptance of the credit offer may be, e.g., the WWAN transceiver 720 or WLAN transceiver 710 and one or more processors 750 with dedicated hardware or implementing executable code or software instructions in memory 760 such as the park assist negotiate unit 768. In another example, the source vehicle may include a means for sending the negotiation requests to the each target vehicle in the multiple target vehicles before receiving a negotiation response from any of the target vehicles, which may be the WWAN transceiver 720 or WLAN transceiver 710 and one or more processors 750 with dedicated hardware or implementing executable code or software instructions in memory 760 such as the park assist negotiate unit 768.

In one implementation, the source vehicle includes a means for sending a park assist confirmation to the parking control server, the park assist confirmation confirming that the source vehicle has parked at the parking space and comprising information related to space around the source vehicle, which may be, e.g., the WWAN transceiver 720 or WLAN transceiver 710 and one or more processors 750 with dedicated hardware or implementing executable code or software instructions in memory 760 such as the park assist confirmation unit 774.

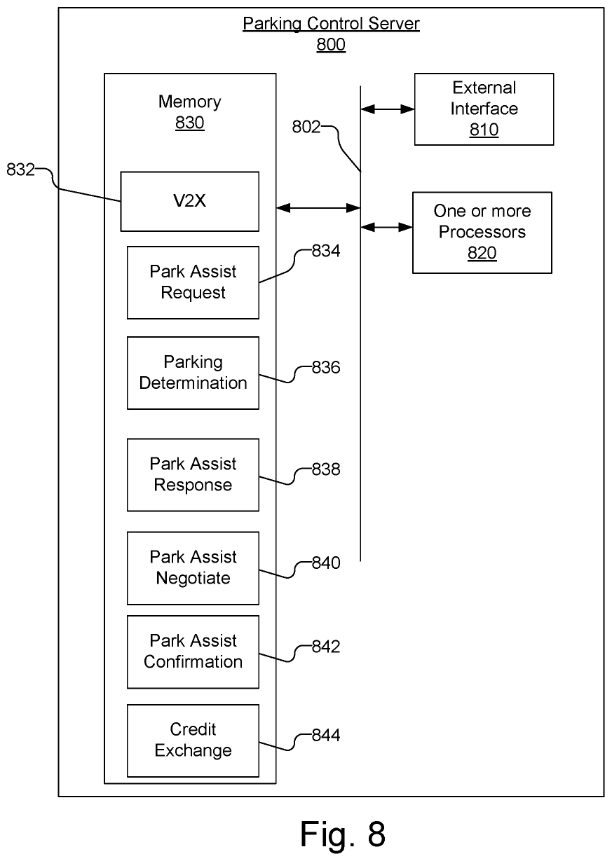

FIG. 8 is a diagram illustrating an example of a hardware implementation of a parking control server 800 capable of V2X communications with V2X entities and engaging in a parking assist session as discussed herein. The parking control server 800 includes, e.g., hardware components such as an external interface (also referred to as communication interface) 810, which may be a wired or wireless communication interface capable of connecting to and communicating with a source vehicle and target vehicles directly or through one or more intermediary networks and/or one or more network entities. The parking control server 800 includes one or more processors 820 and memory 830, which may be coupled together with bus 802. The memory 830 may contain executable code or software instructions that when executed by the one or more processors 820 cause the one or more processors to operate as a special purpose computer programmed to perform the techniques disclosed herein. As illustrated in FIG. 8, the memory 830 may include one or more components or modules that may be implanted by the one or more processors 820 to perform the methodologies as described herein. While the components or modules are illustrated as software in memory 830 that is executable by the one or more processors 820, it should be understood that the components or modules may be dedicated hardware either in the one or more processors 820 or off the processors.

The memory 830 may include a V2X unit 832 that when implemented by the one or more processors 820 enables the one or more processors 820 to receive Vehicle-to-Everything (V2X) messages from the source vehicle and target vehicles via the external interface 810. The V2X unit 832 enable the one or more processors 820 to transmit and receive V2X messages to and from the source vehicle and target vehicles, e.g., with payloads that include information, e.g., as used by the park assist request unit 834, park assist response unit 838, park assist negotiate unit 840, park assist confirmation unit 842, and credit exchange unit 844.

The memory 830 may include a park assist request unit 834, that when implemented by the one or more processors 820 enables the one or more processors 820 to receive a parking assistance request from a source vehicle via the external interface 810. The park assist request unit 834 may enable the one or more processors 820 to receive a credit offer in the park assist request to provide an incentive to a target vehicle that is autonomous to move to provide space for the source vehicle to park. In addition to the credit offer, the park assist request unit 834 may enable the one or more processors 820 to receive at least one of a vehicle identification, size, type, priority, vehicle time to exit, vehicle park time, or a combination thereof.

The memory 830 may include a parking determination unit 836 that when implemented by the one or more processors 820 causes the one or more processors 820 to determine a parking location for a source vehicle based on the information provided in the park assist request message. The parking determination unit 836, for example, may causes the one or more processors 820 to consider factors in the park assist request including the credit offer, as well information about the source vehicle, e.g., the size, type, priority, need for electric charge, received etc. The parking determination unit 836, for example, may causes the one or more processors 820 to also consider factors related to the parking environment that are stored in memory 830 or other storage in the parking control server 800, including available parking space, size of any available space, list of parked vehicles that are available to be moved in response to the offered credit, including locations, space around the parked vehicles, and pre-set credit thresholds. The parking determination unit 836, for example, may causes the one or more processors 820 to generate a location of an available parking location for the source vehicle as well as a list of the target vehicles available to be moved in response to the credit offer, which may be determined, e.g., based on factors such as the battery/fuel used by the target vehicles in providing the parking assistance (e.g., if the target vehicles have been previously moved), if the offered credit is above pre-set thresholds for the target vehicles, the priority/type of the target vehicle, etc.

The memory 830 may include a park assist response unit 838 that when implemented by the one or more processors 820 causes the one or more processors 820 to send a park assist response message via the external interface 810 to the source vehicle. The park assist response message for example may direct the source vehicle to an available parking space and may include a list of target vehicle that may move in response to the credit offer.

The memory 830 may include a park assist negotiate unit 840 that when implemented by the one or more processors 820 enables the one or more processors 820 to engage in a parking assist negotiation with one or more target vehicle via the external interface 810, including sending and receiving negotiation messages. The park assist negotiate unit 840 when implemented by the one or more processors 820 may enable the one or more processors 820 to provide a credit offer to one or more target vehicles and enable the one or more processors 820 to receive a rejection or acceptance of the credit offer.

The memory 830 may include a park assist confirmation unit 842 that when implemented by the one or more processors 820 enables the one or more processors 820 to receive a parking assist confirmation message from the source vehicle via the external interface 810. The park assist confirmation message, for example, may confirm that the source vehicle has parked at the parking space and may include information related to space around the source vehicle, and may further include a desired credit to provide an incentive for the source vehicle to move to provide space for an incoming vehicle to park.

The memory 830 may include a credit exchange unit 844 that when implemented by the one or more processors 820 enables the one or more processors 820 to exchange credits between the source vehicle and target vehicle, e.g., by increasing credit for target vehicles that moved and decreasing credits for the source vehicle 402. The credits may be used, e.g., to decrease or increase the cost of parking. In another implementation, the credit exchange may be a money transfer between vehicles, and thus, the credit exchange may be unrelated to the parking cost. Additionally, the credit exchange may be based on a variable rate, depending on how far the target vehicle moves, how many target vehicles move, whether the target vehicle moves from a high valued parking space (e.g., with a charging station or close to the building entrance), etc., or the credit exchange may be based on a flat rate.

The methodologies described herein may be implemented by various means depending upon the application. For example, these methodologies may be implemented in hardware, firmware, software, or any combination thereof. For a hardware implementation, the one or more processors 820 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of parking control server 800 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a memory (e.g. memory 830) and executed by one or more processors 820, causing the one or more processors 820 to operate as a special purpose computer programmed to perform the techniques disclosed herein. Memory may be implemented within the one or processors 820 or external to the one or more processors 820. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by parking control server 800 may be stored as one or more instructions or code on a non-transitory computer-readable storage medium such as memory 830. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for parking control server 800 may be provided as signals on transmission media included in a communication apparatus. For example, a communication apparatus comprising part or all of parking control server 800 may include a transceiver having signals indicative of instructions and data. The instructions and data are stored on non-transitory computer readable media, e.g., memory 830, and are configured to cause the one or more processors 820 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Thus, a parking control server, such as parking control server 800, may include a means for receiving a park assist request from the source vehicle, wherein the credit offer comprises a credit offer to provide an incentive to a target vehicle that is autonomous to move to provide space for the source vehicle to park, which may be, e.g., the external interface 810 and one or more processors 820 with dedicated hardware or implementing executable code or software instructions in memory 830 such as the park assist request unit 834. A means for determining a target vehicle available to move to provide a parking space for the source vehicle to park based on the credit offer may be, e.g., the external interface 810 and one or more processors 820 with dedicated hardware or implementing executable code or software instructions in memory 830 such as the parking determination unit 836. A means for sending a park assist response to the source vehicle directing the source vehicle to the parking space that is available after the target vehicle moves in response to the credit offer may be, e.g., the external interface 810 and one or more processors 820 with dedicated hardware or implementing executable code or software instructions in memory 830 such as the park assist response unit 838.

In one implementation, the parking control server includes a means for sending a negotiation request from the parking control server to the target vehicle with the credit offer for the target vehicle, which may be, e.g., the external interface 810 and one or more processors 820 with dedicated hardware or implementing executable code or software instructions in memory 830 such as the park assist negotiate unit 840, and a means for receiving a negotiation response from the target vehicle with an acceptance of the credit offer, wherein the target vehicle autonomously moves after accepting the credit offer, which may be, e.g., the external interface 810 and one or more processors 820 with dedicated hardware or implementing executable code or software instructions in memory 830 such as the park assist negotiate unit 840. As a further implementation, the parking control server may include a means for sending a negotiation request from the parking control server to multiple target vehicles with the credit offer for the multiple target vehicles to move to provide space for the source vehicle to park, which may be, e.g., the external interface 810 and one or more processors 820 with dedicated hardware or implementing executable code or software instructions in memory 830 such as the park assist negotiate unit 840, and a means for receiving a negotiation response from the target vehicle with an acceptance of the credit offer from at least one target vehicle in the multiple target vehicles, which may be, e.g., the external interface 810 and one or more processors 820 with dedicated hardware or implementing executable code or software instructions in memory 830 such as the park assist negotiate unit 840.

In one implementation, the parking control server may include a means for receiving a park assist confirmation from the source vehicle, the park assist confirmation confirming that the source vehicle has parked at the parking space and comprising information related to space around the source vehicle, which may be, e.g., the external interface 810 and one or more processors 820 with dedicated hardware or implementing executable code or software instructions in memory 830 such as the park assist confirmation unit 842.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method performed by a source vehicle for assisting in parking of the source vehicle, the method comprising:
sending a park assist request, wherein the park assist request comprises a credit offer to provide an incentive to a target vehicle that is autonomous to move to provide space for the source vehicle to park;
receiving a park assist response directing the source vehicle to a parking space that is available after the target vehicle moves in response to the credit offer; and
autonomously moving the source vehicle into the parking space after the target vehicle has moved.

2. The method of claim 1, wherein the park assist request is sent to the target vehicle and the park assist response is received from the target vehicle.

3. The method of claim 1, wherein the park assist request is sent to a parking control server and the park assist response is received from the parking control server.

4. The method of claim 1, wherein the park assist response includes an identifier for the target vehicle, the method further comprising:
sending a negotiation request to the target vehicle with the credit offer for the target vehicle; and
receiving a negotiation response from the target vehicle with an acceptance of the credit offer, wherein the target vehicle autonomously moves after accepting the credit offer.

5. The method of claim 1, wherein the park assist response includes an identifier for multiple target vehicles, the method further comprising:
sending negotiation requests to each of the multiple target vehicles with the credit offer for the target vehicle; and
receiving a negotiation response from the multiple target vehicles in which at least one target vehicle in the multiple target vehicles accepts the credit offer, wherein the at least one target vehicle in the multiple target vehicles autonomously moves after accepting the credit offer.

6. The method of claim 5, wherein a plurality of target vehicles in the multiple target vehicles accept the credit offer, wherein the plurality of target vehicles autonomously move after accepting the credit offer to provide space for the source vehicle to park.

7. The method of claim 5, wherein sending negotiation requests to each of the multiple target vehicles comprises:
sending a first negotiation request to a first target vehicle;
receiving a first negotiation response from the first target vehicle with a rejection of the credit offer;
sending a second negotiation request to a second target vehicle after receiving the first negotiation response; and
receiving a second negotiation response from the second target vehicle with the acceptance of the credit offer.

8. The method of claim 5, wherein sending negotiation requests to each of the multiple target vehicles comprises sending the negotiation requests to each target vehicle in the multiple target vehicles before receiving a negotiation response from any of the target vehicles.

9. The method of claim 3, further comprising: the parking control server negotiating with the target vehicle and receiving an acceptance of the credit offer from the target vehicle.

10. The method of claim 9, wherein the parking control server receiving the acceptance of the credit offer from the target vehicle before sending the park assist response to the source vehicle.

11. The method of claim 1, wherein the park assist request further comprises at least one of a vehicle identification, size, type, priority, vehicle time to exit, vehicle park time, or a combination thereof.

12. The method of claim 3, further comprising sending a park assist confirmation to the parking control server, the park assist confirmation confirming that the source vehicle has parked at the parking space and comprising information related to space around the source vehicle.

13. The method of claim 12, wherein the park assist confirmation further comprises a desired credit to provide an incentive for the source vehicle to move to provide space for an incoming vehicle to park.

14. A source vehicle capable of engaging in a parking assist session, the source vehicle comprising:
a wireless transceiver configured to wirelessly communicate with entities in a wireless network;
sensors for receiving data used for parking assistance; and
at least one processor coupled to the wireless transceiver and the sensors and configured to:
send a park assist request via the wireless transceiver, wherein the park assist request comprises a credit offer to provide an incentive to a target vehicle that is autonomous to move to provide space for the source vehicle to park;
receive a park assist response via the wireless transceiver directing the source vehicle to a parking space that is available after the target vehicle moves in response to the credit offer; and
autonomously move the source vehicle, based at least in part on signals from the sensors, into the parking space after the target vehicle has moved.

15. The source vehicle of claim 14, wherein the park assist request is sent to the target vehicle and the park assist response is received from the target vehicle.

16. The source vehicle of claim 14, wherein the park assist request is sent to a parking control server and the park assist response is received from the parking control server.

17. The source vehicle of claim 14, wherein the park assist response includes an identifier for the target vehicle, wherein the at least one processor is further configured to:
send, via the wireless transceiver, a negotiation request to the target vehicle with the credit offer for the target vehicle; and
receive, via the wireless transceiver, a negotiation response from the target vehicle with an acceptance of the credit offer, wherein the target vehicle autonomously moves after accepting the credit offer.

18. The source vehicle of claim 14, wherein the park assist response includes an identifier for multiple target vehicles, wherein the at least one processor is further configured to:
send, via the wireless transceiver, negotiation requests to each of the multiple target vehicles with the credit offer for the target vehicle; and
receive, via the wireless transceiver, a negotiation response from the multiple target vehicles in which at least one target vehicle in the multiple target vehicles accepts the credit offer, wherein the at least one target vehicle in the multiple target vehicles autonomously moves after accepting the credit offer.

19. The source vehicle of claim 18, wherein a plurality of target vehicles in the multiple target vehicles accept the credit offer, wherein the plurality of target vehicles autonomously move after accepting the credit offer to provide space for the source vehicle to park.

20. The source vehicle of claim 18, wherein the at least one processor is configured to send negotiation requests to each of the multiple target vehicles by being configured to:
send, via the wireless transceiver, a first negotiation request to a first target vehicle;
receive, via the wireless transceiver, a first negotiation response from the first target vehicle with a rejection of the credit offer;
send, via the wireless transceiver, a second negotiation request to a second target vehicle after receiving the first negotiation response; and
receive, via the wireless transceiver, a second negotiation response from the second target vehicle with the acceptance of the credit offer.

21. The source vehicle of claim 18, wherein the at least one processor is configured to send negotiation requests to each of the multiple target vehicles by being configured to send the negotiation requests to the each target vehicle in the multiple target vehicles before receiving a negotiation response from any of the target vehicles.

22. The source vehicle of claim 16, wherein the parking control server negotiates with the target vehicle and receives an acceptance of the credit offer from the target vehicle.

23. The source vehicle of claim 22, wherein the parking control server receives the acceptance of the credit offer from the target vehicle before sending the park assist response to the source vehicle.

24. The source vehicle of claim 14, wherein the park assist request further comprises at least one of a vehicle identification, size, type, priority, vehicle time to exit, vehicle park time, or a combination thereof.

25. The source vehicle of claim 16, wherein the at least one processor is further configured to send a park assist confirmation to the parking control server, the park assist confirmation confirming that the source vehicle has parked at the parking space and comprising information related to space around the source vehicle.

26. The source vehicle of claim 25, wherein the park assist confirmation further comprises a desired credit to provide an incentive for the source vehicle to move to provide space for an incoming vehicle to park.

27. A method performed by a parking control server for assisting a source vehicle to park, the method comprising:
receiving a park assist request from the source vehicle, wherein the park assist request comprises a credit offer to provide an incentive to one or more vehicles that are autonomous to move to provide space for the source vehicle to park;
determining a target vehicle available to move to provide a parking space for the source vehicle to park based on the credit offer; and
sending a park assist response to the source vehicle directing the source vehicle to the parking space that is available after the target vehicle moves in response to the credit offer.

28. The method of claim 27, wherein the park assist response sent to the source vehicle includes an identifier for the target vehicle, the source vehicle negotiating with the target vehicle and receiving an acceptance of the credit offer from the target vehicle.

29. The method of claim 27, wherein the park assist response sent to the source vehicle includes identifiers for multiple target vehicles, the source vehicle negotiating with the multiple target vehicles and receiving an acceptance of the credit offer from at least one target vehicle in the multiple target vehicles.

30. The method of claim 29, a plurality of target vehicles in the multiple target vehicles accepting the credit offer, the plurality of target vehicles autonomously moving after accepting the credit offer to provide space for the source vehicle to park.

31. The method of claim 27, further comprising:
sending a negotiation request from the parking control server to the target vehicle with the credit offer for the target vehicle; and
receiving a negotiation response from the target vehicle with an acceptance of the credit offer, wherein the target vehicle autonomously moves after accepting the credit offer.

32. The method of claim 31, wherein the parking control server receiving the acceptance of the credit offer from the target vehicle before sending the park assist response to the source vehicle.

33. The method of claim 27, further comprising:
sending a negotiation request from the parking control server to multiple target vehicles with the credit offer for the multiple target vehicles to move to provide space for the source vehicle to park; and
receiving a negotiation response from the target vehicle with an acceptance of the credit offer from at least one target vehicle in the multiple target vehicles.

34. The method of claim 27, wherein the park assist request further comprises at least one of a vehicle identification, size, type, priority, vehicle time to exit, vehicle park time, or a combination thereof and determining the target vehicle available to move to provide the parking space for the source vehicle to park is further based on the at least one of the vehicle identification, size, type, priority, vehicle time to exit, vehicle park time, or the combination thereof.

35. The method of claim 27, further comprising receiving a park assist confirmation from the source vehicle, the park assist confirmation confirming that the source vehicle has parked at the parking space and comprising information related to space around the source vehicle.

36. The method of claim 35, wherein the park assist confirmation further comprises a desired credit to provide an incentive for the source vehicle to move to provide space for an incoming vehicle to park.

37. A parking control server for assisting a source vehicle to park, the parking control server comprising:
an external interface configured to wirelessly communicate with entities in a wireless network; and
at least one processor coupled to the external interface and configured to:
receive, via the external interface, a park assist request from the source vehicle, wherein the park assist request comprises a credit offer to provide an incentive to one or more vehicles that are autonomous to move to provide space for the source vehicle to park;
determine a target vehicle available to move to provide a parking space for the source vehicle to park based on the credit offer; and
send, via the external interface, a park assist response to the source vehicle directing the source vehicle to the parking space that is available after the target vehicle moves in response to the credit offer.

38. The parking control server of claim 37, wherein the park assist response sent to the source vehicle includes an identifier for the target vehicle and the source vehicle negotiates with the target vehicle and receives an acceptance of the credit offer from the target vehicle.

39. The parking control server of claim 37, wherein the park assist response sent to the source vehicle includes identifiers for multiple target vehicles, and the source vehicle negotiates with the multiple target vehicles and receives an acceptance of the credit offer from at least one target vehicle in the multiple target vehicles.

40. The parking control server of claim 39, wherein a plurality of target vehicles in the multiple target vehicles accept the credit offer, wherein the plurality of target vehicles autonomously move after accepting the credit offer to provide space for the source vehicle to park.

41. The parking control server of claim 37, wherein the at least one processor is further configured to:
send, via the external interface, a negotiation request from the parking control server to the target vehicle with the credit offer for the target vehicle; and
receive, via the external interface, a negotiation response from the target vehicle with an acceptance of the credit offer, wherein the target vehicle autonomously moves after accepting the credit offer.

42. The parking control server of claim 41, wherein the parking control server receives the acceptance of the credit offer from the target vehicle before sending the park assist response to the source vehicle.

43. The parking control server of claim 37, wherein the at least one processor is further configured to:
send, via the external interface, a negotiation request from the parking control server to multiple target vehicles with the credit offer for the multiple target vehicles to move to provide space for the source vehicle to park; and
receive, via the external interface, a negotiation response from the target vehicle with an acceptance of the credit offer from at least one target vehicle in the multiple target vehicles.

44. The parking control server of claim 37, wherein the park assist request further comprises at least one of a vehicle identification, size, type, priority, vehicle time to exit, vehicle park time, or a combination thereof and determining the target vehicle available to move to provide the parking space for the source vehicle to park is further based on the at least one of the vehicle identification, size, type, priority, vehicle time to exit, vehicle park time, or the combination thereof.

45. The parking control server of claim 37, wherein the at least one processor is further configured to receive, via the external interface, a park assist confirmation from the source vehicle, the park assist confirmation confirming that the source vehicle has parked at the parking space and comprising information related to space around the source vehicle.

46. The parking control server of claim 45, wherein the park assist confirmation further comprises a desired credit to provide an incentive for the source vehicle to move to provide space for an incoming vehicle to park.
